(19) United States
(12) Patent Application Publication
(10) Pub. No.: US 2016/0280988 A1
(43) Pub. Date: Sep. 29, 2016

(54) APPLICATION OF CHLORINE DIOXIDE TO SUBSURFACE WELLS

(71) Applicants: Timothy Underwood, Tomball, TX (US); Brandon M. Vittur, Houston, TX (US)

(72) Inventors: Timothy Underwood, Tomball, TX (US); Brandon M. Vittur, Houston, TX (US)

(73) Assignee: Baker Hughes Incorporated, Houston, TX (US)

(21) Appl. No.: 14/666,796

(22) Filed: Mar. 24, 2015

(51) Int. Cl. C09K 8/60; E21B 43/25; C09K 8/68

(52) U.S. Cl. CPC C09K 8/605; C09K 8/68; E21B 43/25

(57) ABSTRACT

A method of treating a subsurface well comprises: introducing a treatment fluid comprising a viscosity modifying agent and chlorine dioxide into a well, and wherein the chlorine dioxide is present in an amount of greater than about 1,000 ppm based on the total weight of the treatment fluid.

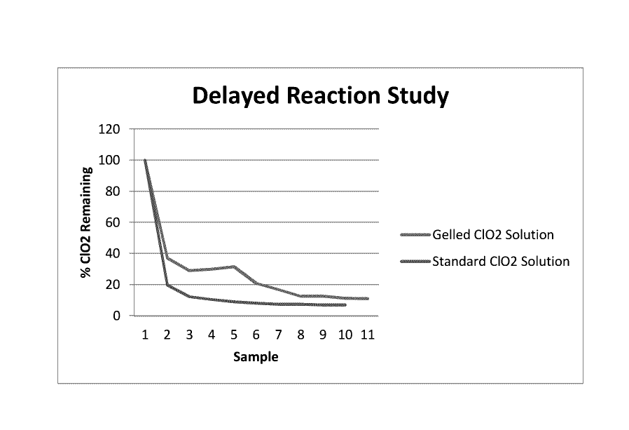

### BACKGROUND

In the oil and gas industry, microbial contamination may occur during drilling, hydraulic fracturing, workover, production, and maintenance operations. The microbes, if left untreated, can grow and proliferate causing severe problems. For example, anaerobic sulfate-reducing bacteria (SRB) of the genus Desulfovibrio can produce undesirable gases, inorganic acids, slime and deposits such as iron sulfide, which may affect the performance of the wells as well as posing safety and health risks.

Biocides have been used in the past to alleviate bacteria problems in injection and production wells. The treatment is typically accomplished by pumping a few hundred barrels of biocide solutions down the well, and allowing the solutions to react with the bacteria, biomass, and the like.

One problem when pumping the biocide solutions down a well is that the solutions tend to be preferentially pumped to areas of higher permeability, and many times even lost to large void areas in the formation. This uneven distribution of the biocides in the well could be especially problematic in long horizontal wells.

In addition, it can be challenging to formulate compositions with high concentrations of certain biocides due to stability issues. Thus the industry is always receptive to improved methods for controlling microbes in downhole environments.

### BRIEF DESCRIPTION

A method of treating a subsurface well comprises: introducing a treatment fluid comprising a viscosity modifying agent and chlorine dioxide into a well, and wherein the chlorine dioxide is present in an amount of greater than about 1,000 ppm based on the total weight of the treatment fluid.

A method of treating a subsurface well comprises: introducing a treatment fluid comprising a viscosity modifying polymer and chlorine dioxide into a well; and applying a shut-in period after introducing the treatment fluid into the well; wherein the viscosity modifying polymer comprises one or more of the following: xanthan; cellulose; hydroxyethylcellulose; carboxymethylcellulose; hydroxypropylcellulose, carboxymethylhydroxyethylcellulose; hydropropyl starch; or lignosulfonate; and wherein the chlorine dioxide is present in an amount of greater than about 3,000 ppm based on the total weight of the treatment fluid.

A method of treating a subsurface well comprises: introducing a spacer fluid into a well; and introducing an aqueous solution of chlorine dioxide into the well; wherein the spacer fluid comprises a polymer comprising one or more of the following: biopolysaccharide; a cellulose derivative; a viscoelastic surfactant gelling agent, or a polymer comprising repeating units derived from one or more of the following monomers: an acrylate; an acrylamide; a vinylpyrrolidone; a vinyl ester; a vinyl alcohol; or a 2-acrylamide-2-methylpropanesulfonic acid.

### BRIEF DESCRIPTION OF THE DRAWINGS

The following descriptions should not be considered limiting in any way.

The FIGURE is a graph illustrating the percentages of ClO₂ remaining in compositions containing a viscosity modifying polymer as well as in compositions without a viscosity modifying polymer.

### DETAILED DESCRIPTION

A detailed description of one or more embodiments of the disclosed composition and method are presented herein by way of exemplification and not limitation.

Chlorine dioxide is a known biocide and has been used to remediate iron and bacteria problems in injection and production wells. Currently, most of the chlorine dioxide used in the oilfield is for pre-treating water before water is used to make solutions for pressure stimulating operations. However, during these treatments, the industries' best practice is to limit the residual chlorine dioxide concentration to a very low level because it is believed that chlorine dioxide can react with viscosity modifying agents in the fracturing fluids thus breaking down the viscosity of these fluids. The potential adverse effects of chlorine dioxide on agents in gel-based fluids have been well documented. For example, Williams et al. describe in U.S. Pat. No. 4,964,466 that dilute aqueous solutions of chlorine dioxide can be used to degrade the gels in the fracturing fluid after fracturing. Perry et al. describe adding various oxygen-chlorine containing oxidizers including chlorine dioxide to friction reducing polymers at low dosage for actually “decomposing” the polymers in U.S. Pat. No. 7,897,063.

The inventors hereof have found that chlorine dioxide is a selective oxidizer and even at a relative high concentration, it does not break down certain viscosity modifying agents as quickly as many people in the oil and gas industry believe. Thus the inventors disclose improved methods for treating undersurface wells by using treatment fluids containing high concentrations of chlorine dioxide. The treatment fluids can be formed by combining chlorine dioxide with viscosity modifying agents such as xanthan; cellulose; or a cellulose derivative. The viscosity modifying agents increase the viscosity of the treatment fluids, which can be beneficial for maintaining the higher concentrations of chlorine dioxide over a longer period of time by reducing gas off as compared to solutions without the viscosity modifying agents. The increased viscosity of the treatment fluids slows down the chlorine dioxide's reaction and provides more effective distribution of chlorine dioxide in undersurface wells. Gelling of high concentrations of chlorine dioxide can also assist with other properties needed for the subsurface oilfield chlorine dioxide applications.

Accordingly, in an embodiment, a method for treating a subsurface well comprises: introducing a treatment fluid comprising a viscosity modifying agent and chlorine dioxide into a well, wherein the chlorine dioxide is present in an amount of greater than about 1,000 ppm based on the total weight of the treatment fluid. Optionally, a spacer fluid is injected into the well prior to or after injection of the treatment fluid containing the viscosity modifying agent and the chlorine dioxide. The spacer fluid can contain a viscosity modifying agent used in the treatment fluid. The method can be used to treat injection wells, production wells, disposal wells, and the equipment associated with these wells.

Additional steps may be included in the method. For example in one embodiment, after introducing the treatment fluid into the well, the well is shut-in for a period of time. During this time the well is closed off so that nothing is introduced into the well. The chlorine dioxide can diffuse out from the treatment fluid and kills, eliminates, or reduces bacteria in the well as well as the bacterial on the surface of the equipment in the well. Chlorine dioxide is also effective at removing iron sulfide, biofilms, and other plugging agents from the well and its associated equipment. Exemplary shut-in times include a few hours (e.g., 1 to 24 hours) to a few (e.g., 2 to 10) days.

The treatment fluids are formed by combining a viscosity modifying agent with a solution of chlorine dioxide. In an embodiment, combining the components of the treatment fluid is accomplished in a vessel such as a mixer, blender, and the like. The order of addition is not particularly limited. For example, the viscosity modifying agent can be added to the solution of chlorine dioxide. Alternatively, the solution of the chlorine dioxide can be added to the viscosity modifying agent. Optional additives can be added before, after, or during the combing. In some embodiments, the composition is injected without mixing, e.g. it is injected “on the fly”. For example, the components can be combined as the treatment fluid is being disposed downhole.

The solution of chlorine dioxide refers to an aqueous solution of chlorine dioxide, which contains an aqueous carrier and chlorine dioxide dissolved in the aqueous carrier. The aqueous carrier can comprise one or more of the following: water; seawater; produced water; or brine. The solution contains greater than about 1,000 ppm, greater than about 2,000 ppm, greater than about 3,000 ppm, greater than about 3,500 ppm, greater than about 4,000 ppm, or greater than about 5,000 pp of chlorine dioxide, based on the total weight of the chlorine dioxide solution. In an embodiment, the solution contains less than about 20 wt. %, less than about 10 wt. %, less than about 5 wt. %, less than about 2 wt. % or less than about 1 wt. % of chlorine dioxide, based on the total weight of the chlorine dioxide solution.

As used herein, viscosity modifying agent used in the treatment fluid and the spacer fluid refers to a material that forms a viscous gel upon contact with water. Exemplary viscosity modifying agents include but are not limited to biopolysaccharides, cellulose and its derivatives such as cellulose ethers and esters, polymers comprising a repeat unit derived from one or more of the following monomers: an acrylate, an acrylamide, a vinlylpyrrolidone, a vinyl ester (e.g., a vinyl acetate), a vinyl alcohol, a-acrylamide-2-methylpropanesulfonic acid; and viscoelastic surfactant (VES) gelling agents. Without wishing to be bound by theory, it is believed that the viscosity modifying polymer has increased viscosity due to long polymer chains that becomes entangled. Entangled polymer chains of the viscosity modifying polymer creates networks, giving complex viscosity behavior. Optionally the viscosity of the functional fluid can be further increased by crosslinking the polymer chains of the viscosity modifying polymer. The crosslinkable groups on the viscosity modifying polymer include carboxylate, phosphonate or hydroxyl groups, or a combination comprising at least one of the foregoing. Crosslinkers for the viscosity modifying polymer include borate, titanate, zirconate, aluminate, chromate, or a combination comprising at least one of the foregoing. Boron crosslinked viscosity modifying polymers include, e.g., guar and substituted guars crosslinked with boric acid, sodium tetraborate, or encapsulated borates; borate crosslinkers may be used with buffers and pH control agents such as sodium hydroxide, magnesium oxide, sodium sesquicarbonate, and sodium carbonate, amines (such as hydroxyalkyl amines, anilines, pyridines, pyrimidines, quinolines, and pyrrolidines, and carboxylates such as acetates and oxalates) and with delay agents such as sorbitol, aldehydes, and sodium gluconate. Zirconium crosslinked viscosity polymers include, e.g., those crosslinked by zirconium lactates (e.g., sodium zirconium lactate), triethanolamines, 2,2′-iminodiethanol, or a combination thereof. Titanates for crosslinking include, e.g., lactates and triethanolamines, and the like.

Suitable biopolysaccharides include natural and derivatized polysaccharides. Exemplary natural polysaccharides include starch, cellulose, xanthan gum, agar, pectin, alginic acid, tragacanth gum, pluran, gellan gum, tamarind seed gum, cardlan, gum arabic, glucomannan, chitin, chitosan, hyaluronic acid, and the like. Modified gums include carboxyalkyl derivatives and hydroxyalkyl derivatives.

Celluloses and derivatives thereof can also be employed and include carboxyalkyl cellulose ethers, such as carboxyethyl cellulose and carboxymethyl cellulose; mixed ethers such as carboxyalkylhydroxyalkyl cellulose ethers, e.g., carboxymethyl hydroxyethyl cellulose; hydroxyalkyl celluloses such as hydroxyethyl cellulose and hydroxypropyl cellulose; alkylhydroxyalkyl celluloses such as methylhydroxypropyl cellulose; alkyl celluloses such as methyl cellulose, ethyl cellulose and propyl cellulose; alkylcarboxyalkyl celluloses such as ethylcarboxymethyl cellulose; alkylalkyl celluloses such as methylethylcellulose; hydroxyalkylalkyl celluloses such as hydroxypropylmethyl cellulose; and the like.

Examples of acrylamide-containing polymers include the homopolymers and copolymers of acrylamide and methacrylamide. Other ethylenically unsaturated monomer can be copolymerized with acrylamide or methacrylamide.

When the viscosity modifying polymers are crosslinked, they can be crosslinked above the ground or alternatively, they can be crosslinked downhole by introducing the viscosity modifying polymers and the crosslinkers simultaneously or sequentially downhole.

The viscoelastic surfactants suitable useful herein include, but are not necessarily limited to, non-ionic, cationic, amphoteric, and zwitterionic surfactants. These surfactants can be used either alone or in combination with inorganic salts or other surfactants to create ordered structures, which result in increased viscosity of aqueous-based fluids. Specific examples of zwitterionic/amphoteric surfactants include, but are not necessarily limited to, dihydroxyl alkyl glycinate, alkyl ampho acetate or propionate, alkyl betaine, alkyl amidopropyl betaine and alkylimino mono- or di-propionates derived from certain waxes, fats and oils. Quaternary amine surfactants are typically cationic, and the betaines are typically zwitterionic. When the surfactant is cationic, it is associated with a negative counterion, which can be an inorganic anion such as a sulfate, a nitrate, a perchlorate or a halide such as Cl, Br or with an aromatic organic anion such as salicylate, naphthalene sulfonate, p and m chlorobenzoates, 3,5 and 3,4 and 2,4-dichlorobenzoates, t-butyl and ethyl phenate, 2,6 and 2,5-dichlorophenates, 2,4,5-trichlorophenate, 2,3,5,6-tetrachlorophenate, p-methyl phenate, m-chlorophenate, 3,5,6-trichloropicolinate, 4-amino-3,5,6-trichlorpicolinate, 2,4-dichlorophenoxyacetate. When the surfactant is anionic, it is associated with a positive counterion, for example, Na+ or K+. When it is zwitternionic, it is associated with both negative and positive counterions, for example, Cl and Na+ or K+. Other viscoelastic surfactant has been described in U.S. Pat. Nos. 7,081,439 and 7,279,446, the disclosure of which is incorporated herein by reference in their entirety. The viscoelastic surfactants may be used in conjunction with an inorganic water-soluble salt or organic additive such as phthalic acid, salicylic acid or their salts.

Amine oxide viscoelastic surfactants can also be used. The amine oxide gelling agents RN⁺(R′)₂O⁻ may have the following structure:

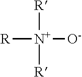

where R is an alkyl or alkylamido group averaging from about 8 to 24 carbon atoms and R′ are independently alkyl groups averaging from about 1 to 6 carbon atoms. In one non-limiting embodiment, R is an alkyl or alkylamido group averaging from about 8 to 16 carbon atoms and R′ are independently alkyl groups averaging from about 2 to 3 carbon atoms. In an alternate, non-restrictive embodiment, the amine oxide gelling agent is tallow amido propylamine oxide (TAPAO), which should be understood as a dipropylamine oxide since both R′ groups are propyl.

In an embodiment, suitable viscosity modifying agent for gelling high concentration of chlorine dioxide includes xanthan (also referred to as “xanthan gum), cellulose, or derivatives of cellulose. Exemplary cellulose derivatives include hydroxyethylcellulose (HEC), carboxymethylcellulose (CMC), hydroxypropylcellulose (HPC), and carboxymethylhydroxyethylcellulose (CMHEC); hydropropyl starch; or lignosulfonate. Combinations of the materials may be used. In an embodiment, the viscosity modifying agent includes at least one of xanthan and carboxymethylcellulose. Optionally, the viscosity modifying agent is not crosslinked.

Without wishing to be bound by theory, it is believed that once the viscosity modifying agent is combined with a chlorine dioxide solution, a gel is formed coating or encapsulating chlorine dioxide. The chlorine dioxide is present at a concentration of greater than about 1,000 ppm, greater than about 2,000 ppm, greater than about 3,000 ppm, greater than about 3,500 ppm, greater than about 4,000 ppm, or greater than about 5,000 ppm, based on the total weight of the treatment fluid. In an embodiment, the treatment fluid contains less than about 20 wt. %, less than about 10 wt. %, less than about 5 wt. %, less than about 2 wt. % or less than about 1 wt. % of chlorine dioxide, based on the total weight of the treatment fluid. In use, chlorine dioxide diffuses out from the treatment fluid and kills, reduces, or removes microbes in the well as well as on the surface of the equipment in the well. Other benefits of using chlorine dioxide include converting iron sulfide to water-soluble iron sulfate, removing biofilms and other plugging agent from the well and its associated equipment. In an embodiment, the chloride dioxide is controllably released from the treatment fluid over a period of a few minutes to a few hours, for example from about 5 minutes to about 48 hours, from about 10 minutes to about 24 hours, or from about 10 minutes to about 5 hours, or from about 10 minutes to about 1 hour.

In the treatment fluid, the viscosity modifying agent is present in an amount effective to stabilize the chlorine dioxide at the desired concentration. In a particular embodiment, the viscosity modifying agent is present at a concentration of about 0.001 to about 0.2 g/cm³, about 0.001 to about 0.1 g/cm³, about 0.001 to about 0.05 g/cm³ or about 0.005 to about 0.01 g/cm³, based on the total volume of the treatment fluid. In another embodiment, the viscosity modifying agent is present at about 0.5 to about 1 wt. % based on the total weight of the treatment fluid.

The amount of viscosity modifying agent in the spacer fluid is about 0.001 to about 0.2 g/cm³, about 0.001 to about 0.1 g/cm³, about 0.001 to about 0.05 g/cm³ or about 0.005 to about 0.01 g/cm³, based on the total volume of the spacer fluid. In another embodiment, the viscosity modifying agent is present at about 0.5 to about 1 wt. % based on the total weight of the spacer fluid. In addition to the viscosity modifying agent, the spacer fluid can also contain water or brine. Other additives known in the art can also be used.

Optionally, various additives are included in the treatment fluid. Exemplary additives include a surfactant, a dispersant, a non-emulsifier, a polymer stabilizer, a clay stabilizer, a biocide different from chlorine dioxide, a corrosion inhibitor, a pH-adjusting agent, or a combination thereof. Other additives known in the art can also be included. In an embodiment, the additive is added to the treatment fluid once a gel has been formed. The additive is present in an amount of about 0.005 vol. % to about 50 vol. %, based on the total volume of the treatment fluid.

The surfactant is anionic, cationic, zwitterionic, or non-ionic. In an embodiment, the non-emulsifier of the additive is a combination of the above surfactants or a combination of surfactant with a short chain alcohol or polyol such as lauryl sulfate with isopropanol or ethylene glycol. The non-emulsifier prevents formation of emulsions in the treatment fluid. The dispersant includes those having poly(alkylene glycol) side chains, fatty acids, or fluorinated groups such as perfluorinated C₁₋₄ sulfonic acids grafted to the polymer backbone. Polymer backbones include those based on a polyester, a poly(meth)acrylate, a polystyrene, a poly(styrene-(meth)acrylate), a polycarbonate, a polyamide, a polyimide, a polyurethane, a polyvinyl alcohol, or a copolymer comprising at least one of these polymeric backbones. There may be overlap among surfactants, VES gelling agents, non-emulsifiers, and dispersants.

The clay stabilizer of the additive prevents the clay downhole from swelling under contact with the treatment fluid. In an embodiment, the clay stabilizer includes a quaternary amine, a brine (e.g., KCl brine), choline chloride, tetramethyl ammonium chloride, and the like.

According to an embodiment, the additive is the pH-adjusting agent, which adjusts pH of the treatment fluid. The pH-adjusting agent is an organic or inorganic acid, or a buffer, which is any appropriate combination of acid and conjugate base. Exemplary inorganic acids include HCl, HBr, fluoroboric acid, sulfuric acid, nitric acid, acetic acid, formic acid, methanesulfonic acid, propionic acid, chloroacetic or dichloroacetic acid, citric acid, glycolic acid, lactic acid, or a combination thereof. In an embodiment, the treatment fluid is substantially free of acid except for an acid derived from chlorine dioxide or the viscosity modifying polymer. As used herein, “substantially free of” means that the treatment fluid contains less than about 5 wt. %, less than about 2 wt. %, less than about 1 wt. %, or less than 0.5 wt. % of acids, based on the total weight of the treatment fluid.

Additional biocides can optionally be included in the treatment fluid. Suitable biocides include those that do not interfere with the other components of the treatment fluid. In an embodiment, the biocide is an aldehyde such as glutaraldehyde. Examples of the biocide include non-oxidizing and oxidizing biocides. Exemplary oxidizing biocides include peracetic acid, potassium monopersulfate, potassium peroxymonosulfate, bromochlorodimethylhydantoin, dichloroethylmethylhydantoin, chloroisocyanurate, trichloroisocyanuric acids, dichloroisocyanuric acids, chlorinated hydantoins, and the like. Additional oxidizing biocides include, e.g., bromine products like: stabilized sodium hypobromite, activated sodium bromide, or brominated hydantoins. Other oxidizing biocides include ozone, inorganic persulfates such as ammonium persulfate, or peroxides, such as hydrogen peroxide and organic peroxides.

Exemplary non-oxidizing biocides include dibromonitfilopropionamide, thiocyanomethylthiobenzothlazole, methyldithiocarbamate, tetrahydrodimethylthladiazonethione, tributyltin oxide, bromonitropropanediol, bromonitrostyrene, methylene bisthiocyanate, chloromethylisothlazolone, methylisothiazolone, benzisothlazolone, dodecylguanidine hydrochloride, polyhexamethylene biguanide, tetrakis(hydroxymethyl) phosphonium sulfate, glutaraldehyde, alkyldimethylbenzyl ammonium chloride, didecyldimethylammonium chloride, poly[oxyethylene-(dimethyliminio) ethylene (dimethyliminio) ethylene dichloride], decylthioethanamine, terbuthylazine, and the like. Additional non-oxidizing biocides are quaternary ammonium salts, aldehydes and quaternary phosphonium salts. In an embodiment, quaternary biocides have a fatty alkyl group and three methyl groups, but in the phosphonium salts, the methyl groups, e.g., are substituted by hydroxymethyl groups without substantially affecting the biocidal activity. In an embodiment, they also are substituted with an aryl group. Examples include formaldehyde, glyoxal, furfural, acrolein, methacrolein, propionaldehyde, acetaldehyde, crotonaldehyde, pyridinium biocides, benzalkonium chloride, cetrimide, cetyl trimethyl ammonium chloride, benzethonium chloride, cetylpyridinium chloride, chlorphenoctium amsonate, dequalinium acetate, dequalinium chloride, domiphen bromide, laurolinium acetate, methylbenzethonium chloride, myristyl-gamma-picolinium chloride, ortaphonium chloride, triclobisonium chloride, alkyl dimethyl benzyl ammonium chloride, cocodiamine, dazomet, 1-(3-chloro allyl)-chloride.3,5,7-triaza-1-azoniaadamantane, or a combination thereof.

It is appreciated that the treatment fluids disclosed herein are not fracturing compositions thus they are substantially free of proppants such as a ceramic, sand, a mineral, a nut shell, gravel, resinous particles, polymeric particles, or a combination thereof. As used herein, “substantially free of proppants” means that the treatment fluids contain less than 2 wt. %, less than 1 wt. %, less than 0.5 wt. %, less than 0.1 wt. %, or contain zero percent of proppants, based on the total weight of the treatment fluid.

A gelled composition containing 660 ppm of chlorine dioxide, 0.38 wt. % of carboxymethylcellulose, and water was prepared. Also prepared was a control composition containing 690 ppm of chlorine dioxide in water without any viscosity modifying polymer. A reducing agent equivalent to 800 ppm of sodium sulfite was added to the gelled composition and the control composition respectively. Samples were taken from the exemplary composition and the control composition over time. The concentrations of the ClO₂ in the samples were measured and the weight percentages of the remaining ClO₂ were calculated. The results are shown in the Table below and illustrated graphically in the FIGURE.

| | |
|---|---|
| Composition | Composition |
| containing viscosity | without viscosity |
| modifying polymer | modifying polymer |

| | ClO₂ | | ClO₂ | |
|---|---|---|---|---|
| | concen- | ClO₂ | concen- | ClO₂ |
| | tration | remaining | tration | remaining |
| Sample | (ppm) | (%) | (ppm) | (%) |
| 1 | 660 | 100 | 692 | 100 |
| 2 | 244 | 37.0 | 136 | 19.6 |
| 3 | 191 | 28.9 | 85 | 12.3 |
| 4 | 197 | 29.8 | 73 | 10.5 |
| 5 | 207 | 31.3 | 61 | 8.8 |
| 6 | 138 | 20.9 | 55 | 7.9 |
| 7 | 111 | 16.8 | 51 | 7.4 |
| 8 | 82 | 12.4 | 50 | 7.2 |
| 9 | 82 | 12.4 | 48 | 6.9 |
| 10 | 74 | 12.4 | 47 | 6.8 |
| 11 | 72 | 11.1 | | |

The results indicate that the composition containing a viscosity modifying polymer does not consume ClO₂ more rapidly than the composition that does not contain the viscosity modifying polymer. Accordingly, using a viscosity modifying polymer for better distribution of the ClO₂ in the well does not cause pre-mature consumption of the ClO₂. Further, the data shows that the viscosity modifying polymer slows down the reactions because higher percentages of ClO₂ can be kept in a composition containing the viscosity modifying polymer as compared to the composition that does not contain the viscosity modifying polymer.

In another embodiment, the viscosity modifying agent is not used together with the aqueous chlorine dioxide solution in the treatment fluid. Rather, the viscosity modifying agent is included in a spacer fluid and injected into the well first. Then an aqueous solution of chlorine dioxide is introduced into the well. Without wishing to be bound by theory, it is believed that the method is also beneficial for slowing down the chlorine dioxide's reaction and providing more effective distribution of chlorine dioxide in undersurface wells. Optionally, the method comprises injecting the spacer fluid and the treatment fluid in an alternating order into the well.

All ranges disclosed herein are inclusive of the endpoints, and the endpoints are independently combinable with each other. The suffix “(s)” as used herein is intended to include both the singular and the plural of the term that it modifies, thereby including at least one of that term (e.g., the colorant(s) includes at least one colorants). “Or” means “and/or.” “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like. “A combination thereof” means “a combination comprising one or more of the listed items and optionally a like item not listed.” All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. (canceled)

2. (canceled)

3. (canceled)

4. The method of claim 18 further comprising allowing the chlorine dioxide to diffuse out from the treatment fluid during the shut-in period.

5. The method of claim 18, wherein a spacer fluid is injected into the well prior to or after injection of the treatment fluid containing the viscosity modifying agent and the chlorine dioxide.

6. The method of claim 5, wherein the spacer fluid comprises one or more of the following: a biopolysaccharide; a cellulose derivative; a viscoelastic surfactant gelling agent, or a polymer comprising repeating units derived from one or more of the following monomers: an acrylate; an acrylamide; a vinylpyrrolidone; a vinyl ester; a vinyl alcohol; or a 2-acrylamide-2-methylpropanesulfonic acid.

7. (canceled)

8. The method of claim 18, wherein the viscosity modifying agent is crosslinked by crosslinking a polymer with a crosslinker.

9. The method of claim 8, wherein the polymer and the crosslinker are introduced sequentially into the well.

10. (canceled)

11. The method of claim 18, wherein the viscosity modifying agent is present in an amount of about 0.001 g/cm³ to about 0.2 g/cm³.

12. The method of claim 18, further comprising combining a solution of chlorine dioxide with a viscosity modifying agent to provide the treatment fluid.

13. The method of claim 12, wherein the solution of chlorine dioxide comprises an aqueous carrier and chlorine dioxide, and wherein the chlorine dioxide is present in an amount of greater than about 3,500 ppm, based on the total weight of the chlorine dioxide solution.

14. The method of claim 18, wherein the treatment fluid further comprises an additive comprising one or more of the following: a surfactant; a dispersant; a non-emulsifier; a clay stabilizer; a biocide different from chlorine dioxide; a corrosion inhibitor; or a pH-adjusting agent.

15. The method of claim 14, wherein the additive is present in an amount of about 0.005 vol. % to about 50 vol. %, based on the total volume of the treatment fluid.

16. (canceled)

17. The method of claim 18, wherein the treatment fluid is substantially free of proppant particles comprising one of more of the following: a ceramic; sand; a mineral; a nut shell; gravel; resinous particles; or polymeric particles.

18. A method of treating a subsurface well and its associated equipment comprising:
introducing a treatment fluid comprising a viscosity modifying polymer and chlorine dioxide into a well; and
applying a shut-in period after introducing the treatment fluid into the well;
wherein the viscosity modifying polymer comprises one or more of the following: xanthan; cellulose; hydroxyethylcellulose; carboxymethylcellulose; hydroxypropylcellulose, carboxymethylhydroxyethylcellulose; hydropropyl starch; or lignosulfonate; and
wherein the chlorine dioxide is present in an amount of greater than about 3,500 ppm and less than about 1 wt. % based on the total weight of the treatment fluid; and
wherein the treatment fluid is substantially free of proppant particles.

19. A method of treating a subsurface well, the method comprising:
introducing a spacer fluid into a well; and
introducing an aqueous solution of chlorine dioxide into the well after introducing the spacer fluid, the chlorine dioxide being present in an amount of greater than about 3,500 ppm and less than about 1 wt. %, based on the total weight of the aqueous solution;
wherein the spacer fluid comprises a polymer comprising one or more of the following: biopolysaccharide; a cellulose derivative; a viscoelastic surfactant gelling agent, or a polymer comprising repeating units derived from one or more of the following monomers: an acrylate; an acrylamide; a vinylpyrrolidone; a vinyl ester; a vinyl alcohol; or a 2-acrylamide-2-methylpropanesulfonic acid.

20. The method of claim 19 comprising injecting the spacer fluid and the aqueous solution of chlorine dioxide in an alternating order into the well.

21. (canceled)

22. (canceled)

23. The method of claim 18, wherein the chlorine dioxide is present in an amount of greater than about 4,000 ppm and less than about 1 wt. %, based on the total weight of the treatment fluid.

24. The method of claim 18, wherein the shut-in period is about 2 days to about 10 days.

25. The method of claim 18, wherein the well is an injection well.

26. The method of claim 18, wherein the well is a production well.

27. The method of claim 18, wherein the well is a waste disposal well.

28. The method of claim 19, wherein the method comprises injecting the space fluid and the treatment fluid in an alternating order into the well.
